(19) United States
(12) Patent Application Publication
(10) Pub. No.: US 2011/0053578 A1
(43) Pub. Date: Mar. 3, 2011

(54) CENTRALIZED CONTROL OF MULTIPLE SERVICES

(75) Inventor: Miles Rochford, London (GB)

(73) Assignee: Nokia Corporation, Espoo (FI)

(21) Appl. No.: 12/551,719

(22) Filed: Sep. 1, 2009

(51) Int. Cl. H04M 3/00

(52) U.S. Cl. 455/418

(57) ABSTRACT

An apparatus comprising means for associating at least one service with a hub application; means for displaying an application window comprising a at least one service view; means for associating at least one service with a service view; means for receiving information from a source; means for processing said information to generate result information; and means for distributing said result information to at least one of said at least one service.

### FIELD

The present application relates to a user interface, an apparatus, a computer program product and a method for centralized control of services, and in particular to a user interface, an apparatus, a computer program product and a method for gathering information from one or more sources and distributing to one or more services.

### BACKGROUND

More and more electronic devices such as mobile phones, MP3 players, Personal Digital Assistants (PDAs) and computers such as netbooks, laptops and desktops are being used to access various services such as social networks or forums. Many users are members of or subscribe to more than one service and it can be a time consuming task to keep track of all updates and events that take place in a service and to keep one's own profile updated in all services and to post items for all services.

Examples of such services are social networks, such as Facebook™, Twitter™ or dating services such as Friendfinder™, and image sharing services such as Flickr™.

The services can also be communication services such as Short Message Service (SMS), Multimedia Message Service (MMS) and various chat programs such as MSN™ and ICQ™.

If a user wants to update his status he has to update the status of each individual service which can be rather time consuming.

In prior art systems it is known to group one or more services into one window to allow faster access. The faster access is achieved by the user not having to switch application or window, but the user is still required to perform each action for each service individually.

An apparatus that allows fast and easy access to multiple services would thus be useful in modern day society.

### SUMMARY

On this background, it would be advantageously to provide a user interface, an apparatus and a method that overcomes or at least reduces the drawbacks indicated above by providing an apparatus according to the claims.

According to a further object of the teachings herein to overcome or at least reduce the drawbacks indicated above an apparatus is providing, said apparatus comprising means for associating at least one service with a hub application; means for displaying an application window comprising a at least one service view; means for associating at least one service with a service view; means for receiving information from a source; means for processing said information to generate result information; and means for distributing said result information to at least one of said at least one service.

According to an embodiment said apparatus comprises means for determining that additional information is needed; means for retrieving said additional information from a source; and means for combining said additional information with said received information during the processing to generate the result information.

According to an embodiment said apparatus comprises means for determining whether a service is relevant for the result information and if so distributing the result information to that service; and if not relevant then not distributing the result information to that service.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIGS. 2a and b are views of each an apparatus according to an embodiment,

FIG. 3 is a block diagram illustrating the general architecture of an apparatus of FIG. 2a in accordance with the present application,

FIGS. 4a to b are screen shot views of an apparatus or according to an embodiment,

FIGS. 5a to h are screen shot views of an apparatus according to an embodiment,

FIGS. 6a to e are schematic diagrams of the relationship between entities according to an embodiment of the application,

FIG. 7 is a view of an embodiment, and

FIG. 8 is a series of flowcharts each illustrating a method according to an embodiment.

### DETAILED DESCRIPTION

In the following detailed description, the user interface, the apparatus, the method and the software product according to the teachings for this application in the form of a cellular/mobile phone, such as a smartphone, will be described by the embodiments. It should be noted that although only a mobile phone is described the teachings of this application can also be used in any electronic device such as in portable electronic devices such as netbooks, desktop computers, laptops, PDAs, mobile communication terminals and other electronic devices offering access to information.

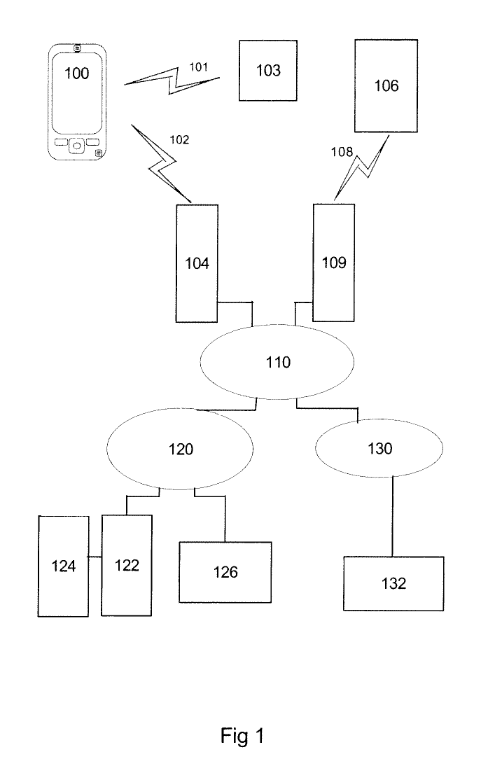

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Spéciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

A computer such as a laptop or desktop can also be connected to the network both via a radio link such as a WiFi link, which is the popular term for a radio frequency connection using the WLAN (Wireless Local Area Network) standard IEEE 802.11.

It should be noted that the teachings of this application are also capable of being utilized in an Internet network of which the telecommunications network described above may be a part of.

It should be noted that even though the teachings herein are described solely to wireless networks it is in no respect to be limited to wireless networks as such, but it to be understood to be usable in the Internet or similar networks.

It should thus be understood that an apparatus according to the teachings herein may be a mobile communications terminal, such as a mobile telephone, a personal digital assistant, a laptop, a notebook, a smartphone as well as a stationary device such as a desktop computer or a server.

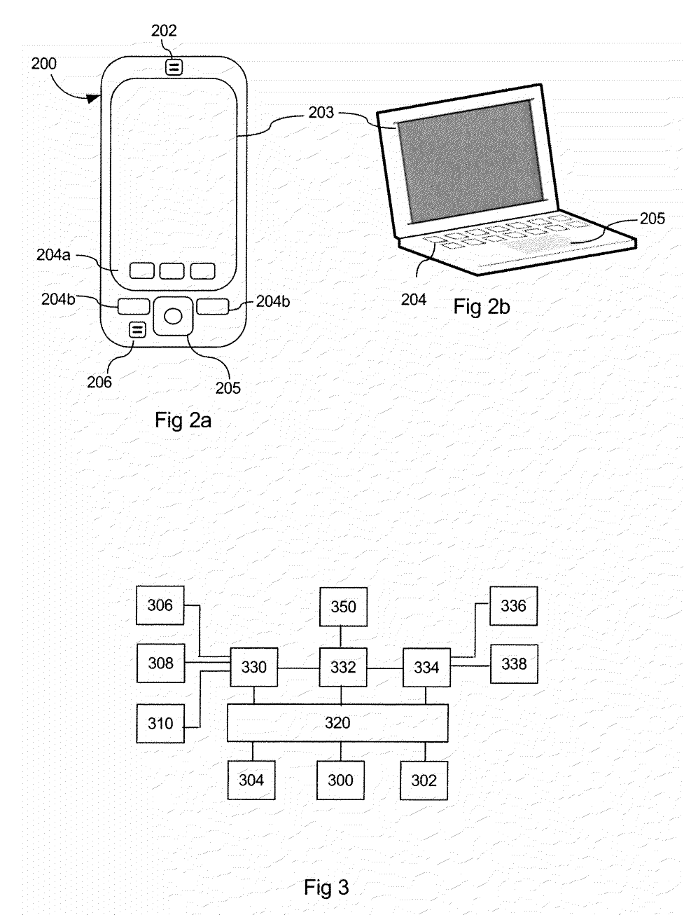

An embodiment 200 of the mobile terminal 100 is illustrated in more detail in FIG. 2a. The mobile terminal 200 comprises a speaker or earphone 202, a microphone 206, a main or first display 203 and a set of keys 204 which may include keys such as soft keys 204b, 204c and a joystick 205 or other type of navigational input device. In this embodiment the display 203 is a touch-sensitive display also called a touch display which displays various virtual keys 204a.

An alternative embodiment of the teachings herein is illustrated in FIG. 2b in the form of a computer which in this example is a laptop computer 200. The computer has a screen 203, a keypad 204 and navigational means in the form of a cursor controlling input means which in this example is a touch pad 205.

It should be noted that a computer can also be connected to a wireless network as shown in FIG. 1 where the computer 200 would be an embodiment of the device 100.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The memory may be formed by separate memory modules. The software includes a real-time operating system 320, drivers for a man-machine interface (MMI) 334, an application handler 332 as well as various applications 350. The applications can include applications for voice calling, video calling, sending and receiving messages such as Short Message Service (SMS), Multimedia Message Service (MMS) or email, web browsing, an instant messaging application, a phone book application, a calendar application, a camera application, one or more video games, a Global Positioning Service (GPS) application etc. It should be noted that two or more of the applications listed above may be executed as the same application.

The MMI 334 also includes one or more hardware controllers, which together with the MMI drivers cooperate with the first display 336/203, and the keypad 338/204 as well as various other Input/Output devices such as microphone, speaker, vibrator, ringtone generator, LED indicator, etc.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory. The memory of the SIM card may form part of the memory 302 in one embodiment.

In the following description it will be assumed that the display is a touch display and that a tap is performed with a stylus or finger or other touching means tapping on a position on the display. It should be noted that a tap may also be included by use of other pointing means such as a mouse or touch pad controlled cursor which is positioned at a specific position and then a clicking action is performed. This analogy is commonly known in the field and will be clear to a skilled person. In the description it will be assumed that a tap input comprises a clicking action at an indicated position.

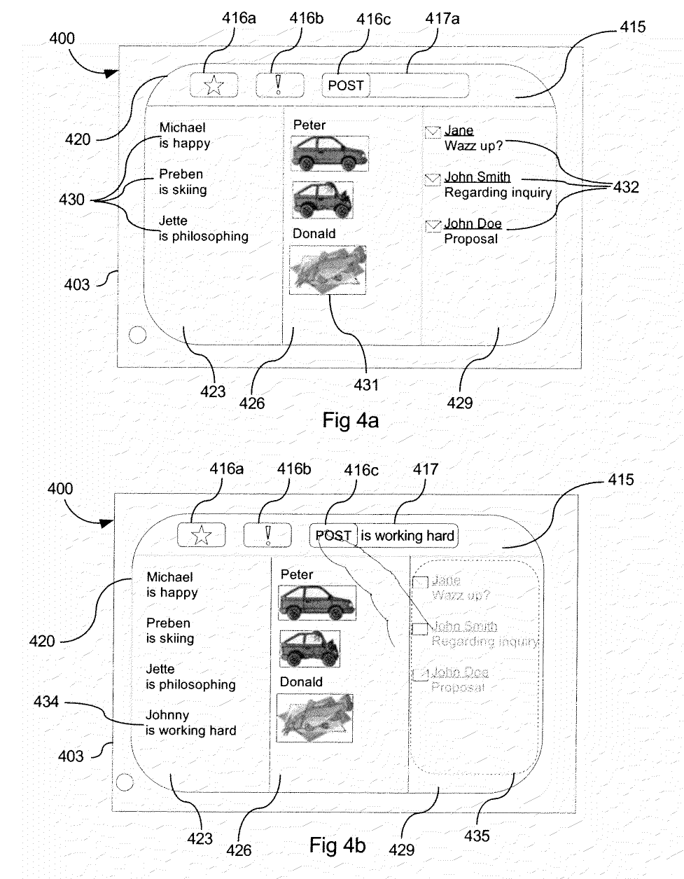

FIG. 4 show a screen shot view of an apparatus 400 according to the teachings herein. It should be noted that such an apparatus is not limited to a laptop, but can be any apparatus capable of accessing services.

The apparatus 400 has a display 403, which in this embodiment is a touch display.

In one embodiment a controller, such as a processor (300), is configured to receive information from a plurality of services and display the received information in one window (420).

It should be noted that the window (420) is in one embodiment a full screen display.

In one embodiment a controller is configured to display an application window 420 comprising a plurality of service views 423, 426 and 429. In this example three service views 423, 426 and 429 are shown, but any number may be used and depends on the number of available services, screen size and user preference.

The application window 420 could be said to belong to a hub application for the services associated with the service views 423, 426, 429.

It should be noted that the services shown are only chosen for illustrative purposes and as should be apparent to a skilled person any number of services exist that may combine the features of the services described herein.

In this example three services are controlled, one in each window 423, 426 and 429. In the leftmost service view 423 a social network service such as Twitter™ is shown. Such a service is used to keep in touch with friends or contacts by updating ones status frequently. In this example a number of status updates 430 are shown.

In the middle service view 426 an image sharing service, such as Flickr™ is shown. Such a service is used to share and comment on images between friends or contacts. In this example two contacts have shared a number of images 431.

In the rightmost service view 429 a text messaging service, such as an electronic mail application, is shown. Such a service is used to send electronic messages between contacts. In this example three messages 432 has arrived from three different contacts.

It should be noted that the order of the service views, their arrangement and placement may differ between embodiments and are dependent on design choices, user preferences, display size and shape and other design criteria and options.

In one embodiment a controller is configured to associate an action that is common to more than one service to a control.

In one embodiment the controller is configured to execute the action on all services in which the action is possible. This has the benefit that an action for many services can be completed with a single action.

In one embodiment such an action is posting a status update.

In one embodiment such an action is sending a message to a plurality of recipients.

In one embodiment such an action is sending a message through a plurality of services. This increases the likelihood of the message reaching the recipient in the shortest time possible as the likely hood of the recipient checking the right service increases with the number of services receiving the message.

In one embodiment such an action is posting a link to an internet site, media content or media content library (such as a gallery or music file collection or playlist) and/or other resource such as a program.

In one embodiment such an action is updating the service view with the latest update(s) for the associated service.

In one embodiment such an action is updating a profile picture.

In one embodiment such an action is synchronizing or updating contact databases for a plurality of services.

In one embodiment the controller is configured to execute the action on the currently active service view 423, 426, 429. This has the advantage that a simpler user interface is achieved that is easier to learn as fewer options and/or buttons are needed to be learnt.

Returning to the example of FIG. 4a also displayed is a control bar 415 in which the controller is configured to display control buttons 416.

In one embodiment the control button 416 is implemented through a label for a softkey.

In this example three control buttons 416a, b and c are displayed.

Control button 416a is associated with marking or commenting an appreciation or acceptance of a statement or status. The control button 416a is in this example marked with a star, however, it should be noted that many markings are possible.

Activation of the control button 416a causes the controller to update a currently viewed status, object or event in a service view 423, 426, 429 with an indication that the status 430, object 431 or event is appreciated.

The control button 416a is thus associated with a different action depending on which event 430 or object 431 that is currently being viewed, where the action for the various objects are of similar nature. This enables a user to quickly find the needed control button to perform an action as the button is the same irrespective of the service being used.

Control button 416b is associated with a commenting function. In the example embodiment of FIG. 4 the control button 416b is marked with an exclamation mark. It should be noted that other markings are possible.

In one embodiment the controller is configured to receive an input indicating one or more objects to comment on.

In one embodiment the object to comment on is already indicated by having been recently viewed.

In one embodiment the controller is configured to display an input window where the user can input a comment.

In one embodiment an input field may be arranged adjacent the control button 416b as for control button 416c (see below) where a user may enter a comment.

As a comment in entered the controller is configured to distribute the comment to all relevant objects in all relevant services. The distribution is from a user point of view the same irrespective of which service is being commented. This allows a user to for example comment on both a status (“Jill has come home from France”) posted in one service and an album (‘France summer 2009’) posted in a different service by selecting the status and the album and then clicking the control button 416b and inputting the comment “Looks like a super holiday!” using a minimum of clicks and only having to learn one button.

Alternatively the status and the album may already be selected if the user has viewed them recently.

In such an embodiment the controller is configured to display an indication of which objects will be commented on and offering a user a possibility to select or deselect objects.

In one embodiment a user can deselect an object in a list by deleting the list entry, tapping the list entry or dragging it from the list or by tapping the object itself.

In one embodiment a user can select an object to be added to a list by tapping the object or dragging the object to the list.

Control button 416c is associated with posting a status update. The control button 416c is further associated with an input field 417.

A controller is configured to upon activation of the control button 416c execute a status update on all services having a status function. Upon activation the status for the relevant services is updated with a text that is entered into the input field 417.

In one embodiment the controller is configured to indicate which services are relevant for specific action. In such an embodiment the controller marks the service view of a service that is relevant to a control button 416 differently from a service that is not relevant as the control button 416 is used.

FIG. 4b shows an example where a user has started inputting a status in the input field 417 being associated with the post status control button 416c. In this example the user has entered the text “is working hard”. Assuming that the service associated with the to rightmost service view 429 is not able to receive status updates, the controller marks it as being not relevant by dimming it. In the example of FIG. 4b this marking is further accentuated by a dashed line 435 around the service view 429. It should be noted that many alternative markings are possible and the ones shown in FIG. 4b are only for illustrative purposes.

As control button 416c is activated, in this example by a user pressing (indicated in FIG. 4b by the finger) on the control button 416c, being a virtual button, the status is posted on the relevant services. In FIG. 4b the service view 423 has been updated accordingly with an additional status 434.

In one embodiment the controller is configured to select one service out of a plurality of services that are able to receive status updates for posting a status update and only post the status update on that service.

In one embodiment the controller is configured to select a service that has the most contacts stored in the contact data base connected to post the status update on.

This has the benefit that a contact will not receive to many identical status updates through different services.

In one embodiment the controller is configured to receive a status update and to determine if the status update is already displayed in a service view 423 for another service. If the status is already displayed the status will mot be displayed again. If the status is not already displayed the controller displays it in the relevant service view 423.

In one embodiment the controller is configured to select one service out of a plurality of services that are able to send messages and only send a composed message via that service.

In one embodiment the controller is configured to select a service that has the most contacts stored in the contact data base connected to send a group message through.

In one embodiment the controller is configured to receive a message and to determine if the message is already displayed in a service view 423 for another service. If the message is already displayed the message will not be displayed again. If the message is not already displayed the controller displays it in the relevant service view 423.

Examples of services are social networks, image sharing applications, forums, news groups, media services, dating services, communication services (SMS, IM, MMS, email, voice or video call lists).

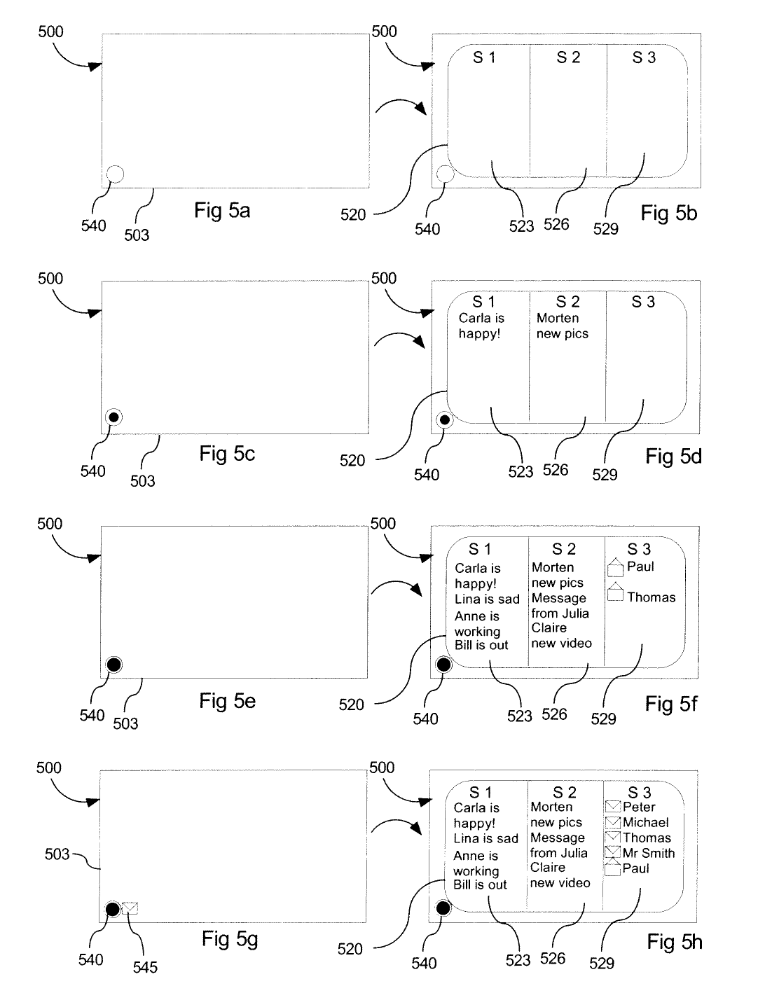

FIG. 5 show an application window 520 associated with an application being executed in an apparatus 500 according to the teachings herein. It should be noted that such an apparatus is not limited to a mobile phone, but can be any apparatus capable of playing media files.

In FIG. 5a a screen shot view of a display 503 of an apparatus 500 is shown.

A controller is configured to display a status indicator 540 for the service hub application described in FIG. 4.

In one embodiment the status indicator indicates the level of activity or number of events/actions that have not been viewed in the hub.

In one embodiment, such as in FIG. 5a no activity is going on and no events have been recorded and this is indicated in this example by the indicator 540 being empty. Launching the hub application would cause the application window 520 to be displayed, as in FIG. 5b, where the service views 523, 526 and 529 are empty.

In one embodiment the hub application is launched by a user tapping or double tapping on the status indicator 540.

In one embodiment the controller is configured to launch the hub application upon receipt of a control sequence. In one such embodiment the control sequence is a key or key combination, for example a combination of the Ctrl and F11 keys normally found on a QWERTY keyboard.

In one embodiment, such as in FIG. 5c a limited activity is going on and only a few events have been recorded and this is indicated in this example by the indicator 540 being half-filled. Launching the hub application would cause the application window 520 to be displayed, as in FIG. 5d, where the service view 523 shows a small number of status updates, the service view 526 shows a small number of events and the service view 529 is empty.

In one embodiment, such as in FIG. 5e a lot of activity is going on and many events have been recorded and this is indicated in this example by the indicator 540 being almost full. Launching the hub application would cause the application window 520 to be displayed, as in FIG. 5d, where the service view 523 shows many status updates, the service view 526 shows a large number of events or objects and the service view 529 shows a number of read messages.

The limits or thresholds or levels corresponding to which indicator 540 is displayed depends on a number of design issues such as expected traffic, and user preference. It should be noted that many alternatives exist for indicating the status of the ongoing activity.

In a further embodiment the controller is configured to indicate if a special event that is of a higher priority than the average event has occurred. For example an incoming message is of higher priority than a status update as the message is addressed directly to you and has been sent to you for a purpose in contrast to the status updates which are of a more general nature with regards to recipients and content.

In one such embodiment a special high priority indicator 545 may be displayed. In one embodiment the high priority indicator 545 is displayed as part of the status indicator 540. In one embodiment the high priority indicator 545 is displayed adjacent the status indicator 540.

In one such embodiment the controller is configured to select high priority indicator 545 that indicates the nature of the high priority event.

In FIG. 5g a user has received a number of messages which is indicated by an envelope indicator 545 being displayed adjacent the status indicator, illustrating a situation similar to that of FIG. 5e. Launching the hub application would cause the application window 520 to be displayed, as in FIG. 5h, where the service view 523 shows many status updates, the service view 526 shows a large number of events or objects and the service view 529 shows a number of unread messages.

In one embodiment a high priority indicator may indicate that an event is urgent, possibly by displaying an exclamation mark ‘!’ as a high priority indicator 545.

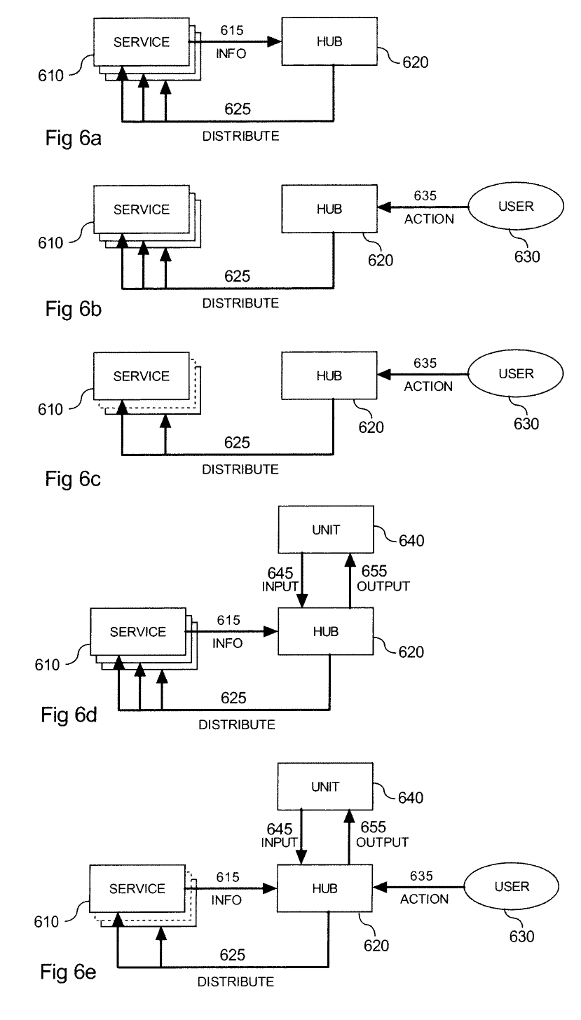

FIG. 6 shows a series of schematic diagrams illustrating the relationships between different entities handled by an embodiment.

FIG. 6a shows the basic setup where one or more is services 610 are related to a hub 620.

In one embodiment the controller is configured to receive information 615 from one service 610 and distribute 625 the information to another service 610.

In one such example where a first service is a VOIP (Voice Over Internet Protocol) application and the second service is a social network application the status is updated as call is being made. For example if a user (Johnny) connects via the VOIP application to a second contact (Jimmy) the status update could be “Johnny is talking to Jimmy”.

In one embodiment the controller is configured to retrieve information 615 actively from a service by querying it.

In one embodiment the controller is configured to retrieve information 615 passively from a service by being notified.

In one embodiment a controller is configured to determine whether a session is on going in a service and distribute information concerning this to one or more other services. One example being updating a status with information on the current session. For example if the controller detects that the user is sending messages to and receiving messages from a contact it can determine that an email session is on going and update a status accordingly; status update: “Bella is emailing Jenny”.

FIG. 6b shows an embodiment in which a controller is configured to receive information relating to an action 635 from a user 630 and to convey said information 635 to the hub application 620.

For example, in one embodiment a controller is configured to receive a user specified status update and to distribute it to all services capable of displaying a status update. In one embodiment the services that the status update is distributed to are user selectable, either upon initiating the status update or by general settings for the hub application 620.

FIG. 6c shows the situation where one service is not able to handle or process the information being distributed or in other words it is not a relevant service for the distribution. In FIG. 6c this is indicated by one service being drawn in dashed lines and that there is no distribution arrow 625 leading to it.

FIG. 6d shows an embodiment in which a controller is configured to receive an input 645 from a unit or device 640. The unit or device 640 is in one embodiment internal to the apparatus and in one embodiment external to the device. In one embodiment a hub 620 is related to both an external unit 640 as well as an internal unit 640. The controller is configured to process the received input and distribute 625 the result of said processing to at least one service 610.

In one embodiment the unit 640 pushes input 645 to the hub application 620, possibly by creating an event.

In one embodiment the hub application polls the unit 640 for the input 645, possibly by a query.

In one example embodiment the unit is a GPS device 640 and the hub application 620 uses the location 645 to update a status with GPS information and distribute it 625.

In one embodiment a controller is configured to retrieve information 615 (or 635) from a service 610 (or a unit 640) in response to receiving information 635 (or 615) from a unit 640 (or a service 610) and to distribute 625 the combined information to at least one service 610.

For example, as a new location is detected the status is updated. An example status update being: “Johanna is in New York”.

In one embodiment a controller is configured to send output 655 to a unit 640. The output is in one embodiment in the form of commands. In one embodiment such a command is a query for additional information.

A first example being that when it is determined that a new country is entered the controller queries a weather data base and possible other databases and updates the status accordingly. One possible status update is: “Morten has arrived in Moscow, the temperature is 23 C. Please mind the time difference (GMT −2)”

A second example: if a GPS unit 640 inputs a specific location corresponding to an arena the controller may query an event calendar to see if there is an ongoing or imminent event at that arena and distribute a status update stating for example “Peter is at an AC/DC concert at Capital Arena”.

In one embodiment the controller is configured to query more than one unit or to combine additional information in the distribution. For the example above the controller may also provide a link to a live feed of the event in question.

In one embodiment a controller is configured to distribute 625 more than one distribution.

For example, the controller is informed 645 by a calendar unit 640 that a user is in a meeting. The controller then distributes the following:
status update “Heinrich is in a meeting”;
command to voice call application to set to automatic message reply; and
command to messaging application to set notification to mute.

Another possible command to distribute is to set a different default communication mode. The default communication mode can be multiple stage access as well. For example if it is detected that a user is in a meeting the preferred contact mode would be to send an email message instead of making a call and if the contact details does not specify an email address then a text message such as an SMS should be sent. IN response to the user accessing a contact and initiating a communication line the appropriate function is launched. For voice call the voice call application is launched. For an email the email editor is launched and for a text message the SMS editor is launched.

FIG. 6e shows a combination of the relationships between services 610, units 640 and a hub 630.

It should be noted that whether an application is deemed to be a service or a unit depends on the current implementation. For example a phonebook application may be a unit whereas the voice call unit is a service. In one implementation the phonebook application may be combined with the voice call application.

Further examples of events and corresponding distributions are shown in table 1.

In one embodiment the hub application is always running, possibly as a background process, while the apparatus is powered on and the controller is configured so that it gathers information on events etc even if the corresponding applications are not active. This provides a user with an always up to date listing of events or other actions that have taken place.

It should be noted that the distributing intelligence lies within the hub application 620. The services 610 and units 640 are mere slaves in that they only provide information 615, 635, as a push or a poll. It is the hub application 620 that determines how the information is distributed, how it is manipulated and packaged, if further supplementary information should be generated or polled, how information is combined and to which services 610 the information should be distributed 625 to.

Through the hub application a user is thus able to keep updated on all events occurring within his social network with a minimum of effort and using a user interface which is easy to learn and use.

In one embodiment two or more services are combined in one service view. The controller is configured to through the hub application to intermesh the data and output from the plurality of services being combined in one service view.

The hub application keeps track of the combined services and interleaves their information to be displayed in a manner that is intelligible to a user. For example by arranging conversations in chronological order regardless of through which service the communication is effected. Or, for example combining the contact lists of two services and using the associated service to communicate with a selected contact. For a group conversation between three contacts, two of which are unable to communicate with each other (perhaps one using email, the other using SMS) the hub application will generate and send copies to make sure all participants are kept up to date in the conversation.

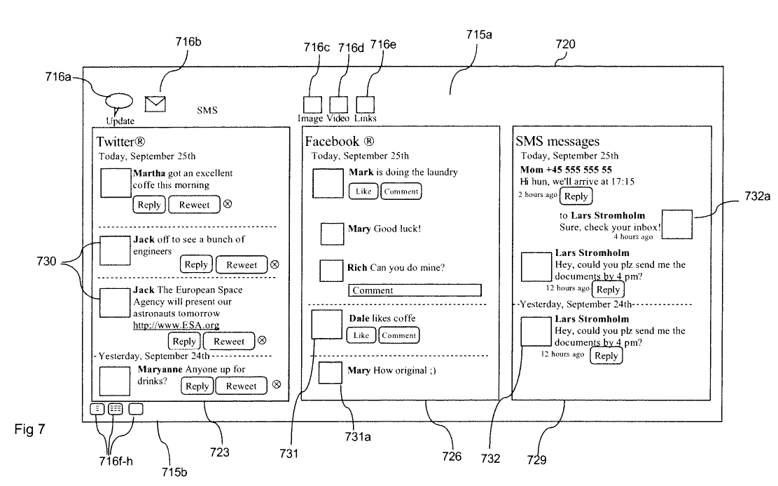

FIG. 7 shows a view of an application window 720 for an embodiment of a hub application. In this example three service views 723, 726, 729 are displayed.

The left most service view 723 is associated with a service being a social forum for posting updates. In this example the service is a known service called “Twitter™”. In the service view 723 several updates 730 from various contacts are displayed.

The middle service view 726 is associated with a service being a social forum for posting updates, sharing images and sending messages. In this example the service is a known service called “Facebook™”. In the service view 726 several updates 731 from various contacts are displayed. Also displayed are comments 731a that have been posted for the updates 731.

The rightmost service window 729 is associated with a text message handling application which in this example is an SMS handling application. In the service view 729 several messages 732 from various contacts are displayed. In this embodiment the replies 732a to messages 732 are also displayed. In this embodiment the replies 732a are displayed along one edge of the service view 729 and the messages 732 replied to are displayed along the opposite edge of the service view 729. This enables a user to quickly ascertain from who the message 732, 732a originates from and to who it is intended.

Above the service views 723, 726, 729 a toolbar is displayed 715a. In the toolbar 715a five control buttons 716a-e are displayed. The functions of these are, from left to right in FIG. 7:
control button 716a, labeled “Update”, is used to post updates;
control button 716b, labeled “SMS”, is used to initiate a text message sending;
control button 716c, labeled “Images”, is used to extrapolate all images currently displayed in the service windows 723, 726, 729 and to display them;
control button 716d, labeled “Videos”, is used to extrapolate all videos currently displayed in the service windows 723, 726, 729 and to display them; and
control button 716e, labeled “Links”, is used to extrapolate all links currently displayed in the service windows 723, 726, 729 and to display them.

A second toolbar 715b is displayed below the service views 723c, 726, 729. In the toolbar 715b three control buttons 716f-h are displayed. The functions of these toolbars is to change the number of service views 723, 726, 729 that are displayed simultaneously (716f and g) and to edit the settings (716h) for the hub application.

The controller is thus configured to receive input from a user (or another application) to change the number of service views displayed.

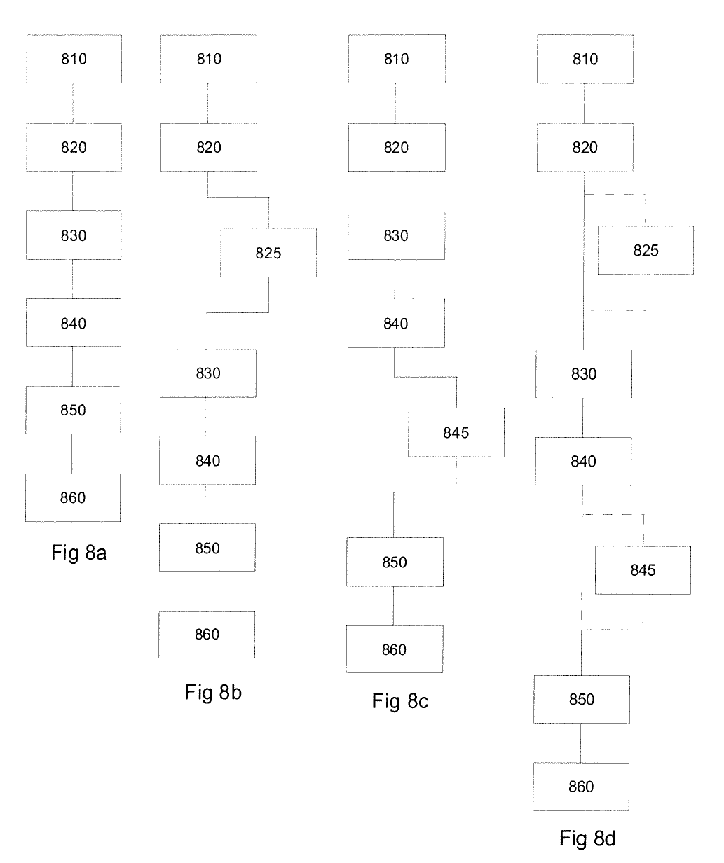

FIG. 8 shows a series of flowcharts of general methods of the embodiments described above. A controller is configured to display a hub application window comprising at least one, or a plurality of, service window(s) 810. Each service view is associated with one or more services 820. Optionally the hub application is also associated with a unit, possibly being an external device 825, see FIG. 8b. The controller receives information from a service (or optionally from a unit) through the hub application 830 and processes the information according to settings in the hub application 840 to generate result information. Optionally the controller determines during the processing that further information is needed and queries a service or a unit for the additional information 845, see FIG. 8c. The processor then determines to which at least one service the result information should be distributed to (i.e. which services are relevant) 850 and distributes the resulting information to the at least one related service 860.

FIG. 8d shows a combination of the methods above, where the dashed lines indicate that the two paths are optional to one another and depends on the present embodiment and the current situation to which the method is applied.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, media players, personal organizers, computers or any other device designed for playing media files.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user will more quickly and efficiently maintain a plurality of services updated with out having to update each service individually and thus keep in more touch with his social networks.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone and a laptop computer, it should be appreciated that the teachings of the present application may also be applied to other types of electronic devices, such as media players, video players, photo and video cameras, palmtop, netbooks, laptop and desktop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

### Tables

TABLE 1
Examples of events in units and/or services
and the resulting distributions.

| | | Information |
|---|---|---|
| Unit/Service | Event | distributed |
| IM application | An ongoing chat | Status update: |
| | session | “Johnny is chatting |
| | | with Jimmy” |
| Calendar | Ongoing meeting | Status is updated |
| application | | Messaging services |
| | | are set to |
| | | automatic reply |
| | | Call services are |
| | | set to automatic |
| | | reply with message |
| Location | A new location is | Status is updated |
| finder | entered | (“John is on Moscow”) |
| | | Possibly followed |
| | | by extra information |
| | | on the location, which |
| | | may be retrieved form |
| | | an external source |
| | | (“mind the time |
| | | difference” or “the |
| | | temperature is 24 C.”) |
| Location | User is detected to | Status update: |
| finder and | be close to an event | “Jimmy is at an |
| calendar | scheduled in a | AC/DC concert” |
| | calendar. The | possibly offering |
| | calendar may be a | further information |
| | remote event | such as a live feed |
| | calendar | to the event. |
| Pulse monitor | Training result | Update status with |
| | achieved | training result |
| Pulse monitor | Pulse indicates | Command voice call |
| | heart failure | application to call |
| | | emergency number |
| Call | Ongoing call | Update status |
| application | | (“John is talking |
| | | to Jimmy”) |
| Call | Ongoing call | Change default |
| application | | contact mode from |
| | | call to IM, SMS or |
| | | email for example |
| Message | New business card | Update all contact |
| application | received | lists, for call |
| | | applications, message |
| | | applications and in |
| | | social networks with |
| | | a multiple distribution. |
| | | Also search social |
| | | networks for a match. |
| Message | Message received | Query search engine |
| application | from contact not in | for details |
| | database | Update phonebooks |
| | | and contact lists |
| | | Search social network |
| | | applications for a |
| | | match. |
| Media store | Purchase of new | Share content with |
| | media file | list of friends. |
| | | Update status |
| | | (“John bought |
| | | Madonna's ‘Like a |
| | | Virgin’”) and |
| | | provide link to |
| | | purchase or listen |
| | | to sample. |
| Multimedia | New pictures received | Pictures are shared |
| Communication | | on picture sharing |
| application | | services or |
| (MMS or email) | | applications. |
| GPS | Enter new roaming | Query local network |
| | area | provider for tariff |
| | | and distribute command |
| | | to communication |
| | | applications to set a |
| | | default mode of contact |
| | | according to the tariff. |
| | | Possibly update status: |
| | | “John is in Romania |
| | | and wont be checking his |
| | | emails due to high data |
| | | traffic costs” |
| GPS | Extract activity | Distribute status |
| | from GPS data such | updates such as: |
| | as location and/or | “John is sailing” |
| | speed. | if location is at sea; |
| | | “John is trekking” - |
| | | if location is on |
| | | a mountain; |
| | | “John is riding his |
| | | MC” if speed is high. |
| | | The activities may |
| | | be set to associate |
| | | a type of location |
| | | or a specific location |
| | | by the user or by an |
| | | application. |
| Social network | Update phonebook or | Distributes the |
| service | contact list | update to other |
| | | services having a |
| | | phonebook or a |
| | | contact list. |
| Social network | Updated profile | Distribute picture |
| service | picture | and update contact |
| | | list for the contact |
| | | in applications having |
| | | a contact list or |
| | | phonebook capable |
| | | of showing pictures |
| | | of a contact. |
| Video game | New high score | Update status |
| | achieved | informing others. |
| | | Possibly providing |
| | | a link to the game. |
| Video game | Killing or creating | Informing on relevant |
| | of a character | social networks. |
| | | Posting picture of |
| | | character on image |
| | | sharing services. |
| Camera | New picture taken | Posting pictures on |
| application | | image sharing service. |
| Camera | New picture taken | Sending the picture |
| application | and using a face | to the recognized |
| | recognition application | person or update a |
| | recognizing a face | profile picture of |
| | in the picture and | the person in social |
| | | network service and/ |
| | | or contact database. |

1. An apparatus comprising a controller, wherein said controller is arranged to
associate at least one service with an application window;
display said application window comprising a at least one service view;
associate at least one service with a service view;
receive information from a source;
process said information to generate result information; and to
distribute said result information to at least one of said at least one service.

2. An apparatus according to claim 1, wherein the controller is configured to:
determine that additional information is needed;
retrieve said additional information from a source; and
to combine said additional information with said received information during the processing to generate the result information.

3. An apparatus according to claim 1, wherein the controller is configured to:
determine whether a service is relevant for the result information and if so distribute the result information to that service;
and if not to not distribute the result information to that service.

4. An apparatus according to claim 1, wherein said source is one taken from a group comprising: service; a unit and an input device configured to receive input from a user.

5. An apparatus according to claim 1, wherein said received information indicates an action.

6. An apparatus according to claim 5, wherein the controller is configured to:
display a control button;
associate said control button with said action
receive input indicating an activation of said control button and in response thereto
execute said action.

7. An apparatus according to claim 5, wherein the controller is configured to:
execute said action for a plurality of services by for
determining a command corresponding to said action for each service and to distribute the command to the service.

8. An apparatus according to claim 7, wherein the controller is configured to:
for each of the at least one services being associated with the application window determine whether the service is relevant for the action and only if so execute the action for that service.

9. An apparatus according to claim 1, wherein said received information is data to be distributed or displayed.

10. An apparatus according to claim 1, wherein said result information is data to be displayed or distributed and/or said result information is a command to be executed within a service.

11. A method for use in an apparatus comprising at least a processor, said method comprising:
associating at least one service with an application window;
displaying said application window comprising at least one service view;
associating at least one service with a service view;
receiving information from a source;
processing said information to generate result information; and
distributing said result information to at least one of said at least one service.

12. A method according to claim 11, said method further comprising:
determining that additional information is needed;
retrieving said additional information from a source; and
combining said additional information with said received information during the processing to generate the result information.

13. A method according to claim 11, said method further comprising:
determining whether a service is relevant for the result information and if so distributing the result information to that service;
and if not relevant then not distributing the result information to that service.

14. A method according to claim 11, wherein said source is one taken from a group comprising: service; a unit and an input device configured to receive input from a user.

15. A method according to claim 11, wherein said received information indicates an action.

16. A method according to claim 15, said method further comprising:
displaying a control button;
associating said control button with said action
receiving input indicating an activation of said control button and in response thereto
executing said action.

17. A method according to claim 15, said method further comprising:
execute said action for a plurality of services by for
determining a command corresponding to said action for each service and to distribute the command to the service.

18. A method according to claim 17, said method further comprising:
for each of the at least one services being associated with the application window determine whether the service is relevant for the action and only if so execute the action for that service.

19. A method according to claim 11, wherein said received information is data to be distributed or displayed.

20. A method according to claim 11, wherein said result information is data to be displayed or distributed and/or said result information is a command to be executed within a service.

21. A computer readable medium comprising at least computer program code for controlling an apparatus, said computer readable medium comprising:
software code for associating at least one service with an application window;
software code for displaying said application window comprising a at least one service view;
software code for associating at least one service with a service view;
software code for receiving information from a source;
software code for processing said information to generate result information; and
software code for distributing said result information to at least one of said at least one service.
